(19) United States
(12) Patent Application Publication
(10) Pub. No.: US 2026/0266300 A1
(43) Pub. Date: Sep. 10, 2026

(54) PORTABLE FAN

(71) Applicant: MILWAUKEE ELECTRIC TOOL CORPORATION, Brookfield, WI (US)

(72) Inventors: Max D. Mutza, Menomonee Falls, WI (US); David W. Draeger, Sussex, WI (US); Victor G. Cinq-Mars, Milwaukee, WI (US)

(21) Appl. No.: 19/557,834

(22) Filed: Mar. 5, 2026

Related U.S. Application Data
(60) Provisional application No. 63/768,378, filed on Mar. 7, 2025.

(51) Int. Cl. F04D 25/08; F04D 19/00; F04D 25/06; F04D 29/52; F04D 29/64; F16M 13/00; F16M 13/02

(52) U.S. Cl. CPC F04D 25/08; F04D 19/002; F04D 25/0673; F04D 29/522; F04D 29/646; F16M 13/005; F16M 13/022

(57) ABSTRACT

A portable fan includes a main body with first and second ends and a fan head positioned between them. The fan head includes a fan selectively powered by a power source. A first arm is rotatably coupled to the main body relative to the fan head and has a first distal end. A second arm is rotatably coupled to the main body relative to the fan head and the first arm and has a second distal end. The second arm is rotatable relative to the first arm between a first arm position and a second arm position. In the first arm position, the second distal end is coupled to the first distal end. In the second arm position, the second distal end is spaced apart from the first distal end.

### CROSS-REFERENCE TO RELATED APPLICATIONS

The application claims priority to U.S. Provisional Patent Application No. 63/768,378, filed March 7, 2025, the entire contents of which are incorporated by reference herein.

### FIELD OF THE DISCLOSURE

The present disclosure relates to a portable fan.

### BACKGROUND OF THE DISCLOSURE

Portable fans provide an airflow to a surrounding environment.

### SUMMARY OF THE DISCLOSURE

The present disclosure provides, in one aspect, a portable fan including a main body having a first end and a second end opposite the first end. The portable fan includes a fan head coupled to the main body between the first end and the second end. The fan head includes a fan configured to be selectively powered by a power source. The portable fan includes a first arm rotatably coupled to the main body relative to the fan head. The first arm includes a first distal end opposite from the main body. The portable fan includes a second arm rotatably coupled to the main body relative to the fan head and the first arm. The second arm includes a second distal end opposite the main body and is rotatable relative to the first arm between a first arm position and a second arm position. In the first arm position, the second distal end is coupled to the first distal end. In the second arm position, the second distal end is spaced apart from the first distal end.

The present disclosure provides, in another aspect, a portable fan including a main body and a fan head coupled to the main body. The fan head includes a fan configured to be selectively powered by a power source. The portable fan includes a first arm rotatably coupled to the main body relative to the fan head. The first arm includes a first projection extending outwardly from the main body. The first arm includes a second projection spaced apart from the first projection. The second projection extends outwardly from the main body generally parallel to the first projection. The first projection and the second projection define a gap therebetween. The gap is configured to receive a support structure to support the portable fan on the support structure.

The present disclosure provides, in another aspect, a portable fan including a main body having a first end and a second end opposite the first end. The portable fan includes a fan head coupled to the main body between the first end and the second end. The fan head includes a fan configured to be selectively powered by a power source. The portable fan includes a first arm rotatably coupled to the main body relative to the fan head. The first arm includes a first distal end opposite from the main body. The portable fan includes a second arm rotatably coupled to the main body relative to the fan head and the first arm. The second arm includes a second distal end opposite the main body. The second arm is rotatable relative to the first arm between a first arm position and a second arm position. In the first arm position, the second distal end is coupled to the first distal end such that the first arm and the second arm cooperate to form a closed loop. In the second arm position, the second distal end is spaced apart from the first distal end. The fan head is rotatable relative to the first arm and the second arm between a first fan head position and a second fan head position. In the first fan head position, a portion of the fan is received in the closed loop. In the second fan head position, the fan head is spaced apart from the closed loop.

### BRIEF DESCRIPTION OF THE DRAWINGS

FIG. 1 is a top perspective view of a portable fan according to a construction of the disclosure.

FIG. 2 is a bottom perspective view of the portable fan of FIG. 1.

FIG. 3 is a perspective view of the portable fan of FIG. 1 illustrating a first arm side of the portable fan.

FIG. 4 is a perspective view of the portable fan of FIG. 1 illustrating a second arm side of the portable fan.

FIG. 5 is a perspective view of the portable fan of FIG. 1 having arms of the fan spaced from one another.

FIG. 6 is an enlarged view of distal ends of the arms spaced from one another.

FIG. 7 is a cross-sectional view taken along lines 7-7 of FIG. 6.

FIG. 8 is a perspective view of the portable fan of FIG. 1 in another position.

FIG. 9 illustrates the portable fan of FIG. 1 hung from a horizontal piece of wood.

FIG. 10 illustrates the portable fan of FIG. 1 hung from a vertical piece of wood.

FIG. 11 illustrates the portable fan of FIG. 1 hung from a nail.

FIG. 12 illustrates the portable fan of FIG. 1 hung from a tube.

FIG. 13 illustrates the portable fan of FIG. 1 mounted to a door.

FIG. 14 illustrates the portable fan of FIG. 1 mounted to a vertical wall.

FIG. 15 illustrates the portable fan of FIG. 1 mounted to a flat ferromagnetic surface.

FIG. 16 illustrates the portable fan of FIG. 1 mounted to a curved ferromagnetic wall.

FIG. 17 illustrates the portable fan of FIG. 1 standing on flooring with one of the arms.

FIG. 18 illustrates the portable fan of FIG. 1 standing on a horizontal surface with both of the arms.

FIG. 19 illustrates the portable fan of FIG. 1 stowed in a first head position.

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

### DETAILED DESCRIPTION

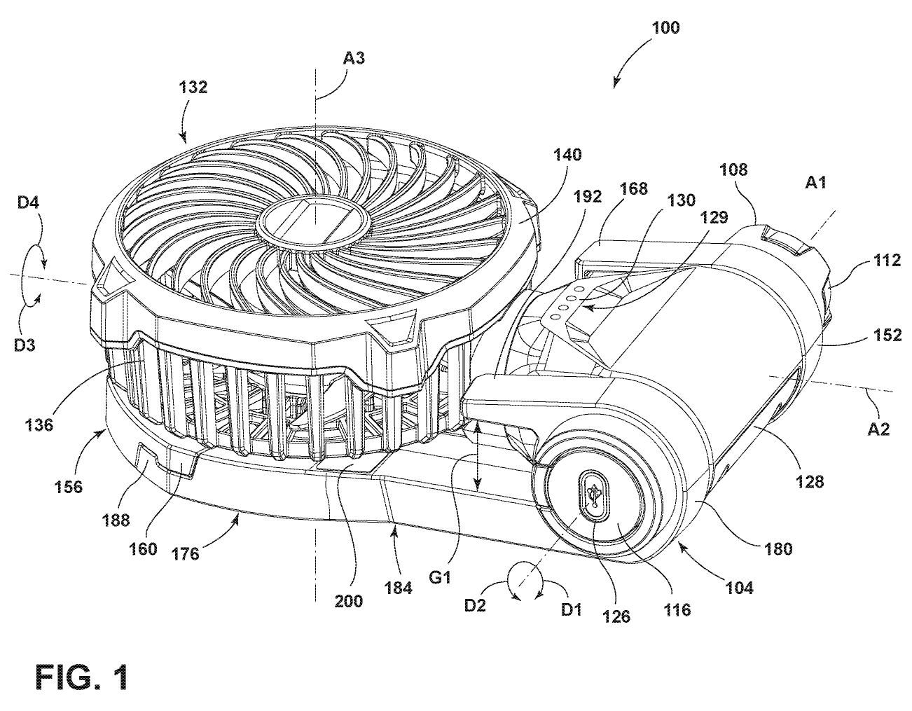

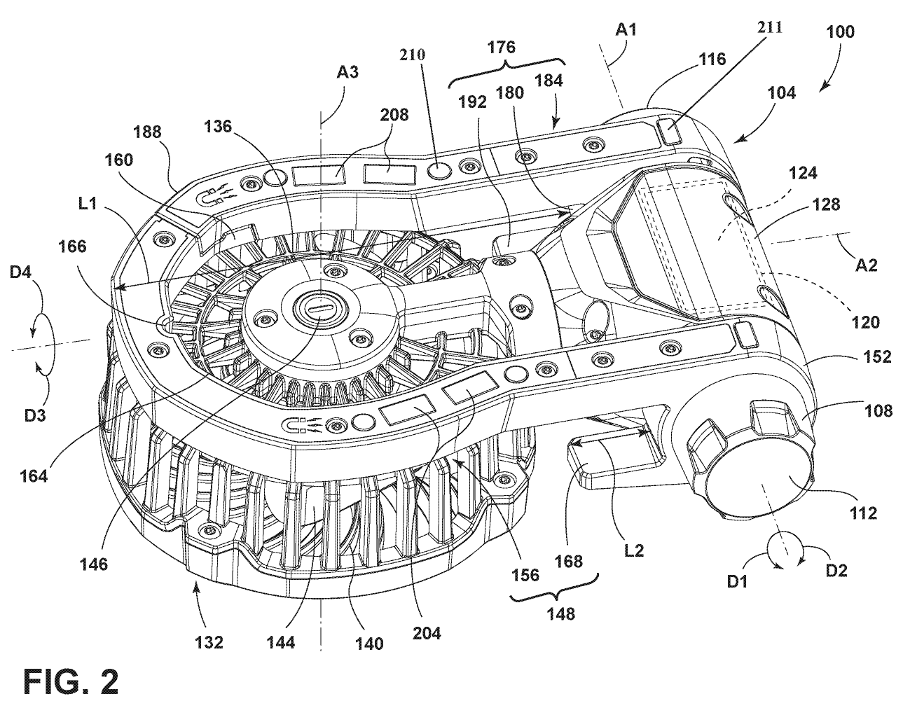

FIGS. 1 and 2 illustrate a portable fan 100 according to a construction of the present disclosure. The portable fan 100 includes a main body 104 having an end cap 108 that is selectively coupled to the main body 104. In the illustrated construction, the main body 104 is cylindrical. The main body 104 includes a first end 112 and a second end 116 that is opposite from the first end 112. The main body 104 includes a battery receptacle 120 configured to receive a power source 124 (e.g., a battery) and the cap 108 is configured to retain the power source 124 within the battery receptacle 120. In other words, the battery receptacle 120 is sealed by coupling the cap 108 to the main body 104. The main body 104 includes a rubber cover 126 disposed on the second end 116 that protects a charging port for charging the power source 124. The portable fan 100 can be operated while the power source 124 is being charged. In the illustrated embodiment, the power source 124 is a 4-volt rechargeable power tool battery. The power source 124 may include one or more battery cells having, for example, a lithium (Li), lithium-ion (Li-ion), or other lithium-based chemistry. For example, the battery cells may have a chemistry of lithium-cobalt (Li-Co), lithium-manganese (Li-Mn) spinel, or Li-Mn nickel. In other constructions, the battery cells may have a nickel-cadmium, nickel-metal hydride, or lead-acid battery chemistry. In the illustrated construction, the battery 124 is a single cell battery. In the illustrated construction, the battery 124 has a positive terminal and a negative terminal disposed on the same end of the longitudinal end of the battery 124. That is, the positive and the negative terminal share an end of the battery 124. Additional details regarding the battery 124 and/or functions thereof are disclosed in U.S. Patent Application No. 19/382,461, the entire contents of which are incorporated herein by reference.

With continued reference to FIGS. 1 and 2, the main body 104 defines a longitudinal axis A1 extending centrally through the first end 112 and the second end 116. The battery receptacle 120 is configured to receive the power source 124 along the longitudinal axis A1 when the cap 108 is removed. In the illustrated construction, the battery 124 is cylindrical and is therefore received longitudinally along the longitudinal axis A1. The battery 124 defines an axis that is aligned with the longitudinal axis A1 when the battery 124 is received in the battery receptacle 120. In other words, the battery 124 is concentrically arranged in the battery receptacle 120. The portable fan 100 includes a rear housing or central member 128 that is disposed on the main body 104. The central member 128 at least partially defines a bearing surface for one or more joints that couple the fan head 132 to main body 104. In the illustrated construction, the central member 128 is rotatable about the longitudinal axis A1 relative to the main body 104. The central member 128 is located between the first end 112 and the second end 116. The central member 128 defines a bisecting axis A2 that extends centrally through the central member 128 and is perpendicular to the longitudinal axis A1. The central member 128 includes an indicator 129 that reflects the state of charge of the battery 124. In the illustrated construction, the indicator 129 includes four apertures 130 disposed alone a single line. The apertures 130 are in communication with four lights that each correspond to the state of charge of the battery 124. In other embodiments, the indicator 129 may be located elsewhere on the portable fan 100 and/or have other configurations.

The portable fan 100 includes a fan head 132 coupled to the main body 104. In the illustrated construction, the fan head 132 is disposed between the first end 112 and the second end 116 of the main body 104. Specifically, the fan head 132 is coupled to the main body 104 via the central member 128 such that the fan head 132 is rotatable about the longitudinal axis A1 relative to the main body 104. The fan head 132 includes an inlet grate 136, an outlet grate 140 coupled to the inlet grate 136, and a fan 144 surrounded by the inlet grate 136 and the outlet grate 140. In the illustrated construction, the inlet grate 136 is rotatably coupled to the central member 128 such that the fan head 132 is rotatable about the bisecting axis A2 relative to the main body 104. The fan head 132 has dual pivot articulation. In other words, the fan head 132 is movable about the longitudinal axis A1 and the bisecting axis A2. The fan 144 is configured to be selectively powered by the power source 124. Specifically, the fan 144 is coupled to a rotor of a motor (e.g., a brushless DC electric motor) which is selectively supplied power from the power source 124 such that the fan 144 is rotated. The fan 144 defines a fan axis A3 that extends centrally through the fan 144 and is perpendicular to the bisecting axis A2 such that an airflow can be generated parallel to the fan axis A3. The fan head 132 includes a power button 146 that toggles the portable fan 100 on and off. In other words, the power button 146 enables and disables energy supply from the battery 124 to the motor. In the illustrated construction, the power button 146 is disposed on the inlet grate 136 and is concentric with the fan axis A3. In other constructions, the power button 146 may be located elsewhere on the fan head 132 or the portable fan 100. The fan 144 draws in air through the inlet grate 136 and expels the air through the outlet grate 140. In the illustrated construction, the fan 144 includes a total of five blades.

Although the illustrated device is a portable fan including a fan head, in other embodiments, the device may include other types of output heads. For example, the device may be a portable speaker including a speaker head or a portable light including a light head. The speaker head or the light head may be coupled to and movable relative to the main body 104 in a similar manner as the fan head 132, and have similar profiles as the fan head 132, but with different output elements (e.g., speakers, LEDs, etc.) rather than the fan 144, motor, and other components specific to the fan head 132. In some embodiments, the device may be a combination device and include a combination head, such as a combination fan and light head, a combination speaker and light head, or a combination fan, speaker, and light head.

With reference to FIGS. 1 and 2, the portable fan 100 includes a first arm 148 rotatably coupled to the main body 104 about the longitudinal axis A1 relative to the fan head 132. Specifically, the first arm 148 includes a circular band 152 rotatably coupled to the main body 104 about the longitudinal axis A1 relative to the fan head 132. The first arm 148 is disposed between the first end 112 and the second end 116. Specifically, the circular band 152 is disposed between the first end 112 and the central member 128. The first arm 148 includes a first projection 156 extending outwardly from the main body 104. Specifically, the first projection 156 extends from the circular band 152. The first arm 148 includes a first distal end 160. In the illustrated construction, the first projection 156 defines the first distal end 160 (e.g., opposite a portion of the first projection 156 that extends from the circular band 152). The first projection 156 includes a bend 164 disposed between the first distal end 160 and the portion of the first projection 156 extending from the circular band 152 such that the first projection 156 defines a J-shape or a hook. Due to the hook shape of the first projection 156, the first distal end 160 is disposed on an opposite side of the bisecting axis A2 from the circular band 152. In other constructions, the first projection 156 defines an L-shape (e.g., the bend 164 is a 90-degree bend between the first distal end 160 and the portion of the first projection 156 that extends from the circular band 152). The first projection 156 defines a first length L1 measured in a direction perpendicular to the longitudinal axis A1 from the circular band 152. The first projection 156 includes a recess 166. In the illustrated construction, the recess 166 is disposed in a portion of the bend 164. In the illustrated construction, the recess 166 is shaped to receive an exposed nail on a wall.

The first arm 148 includes a second projection 168 spaced apart from the first projection 156 and extending outwardly from the main body 104. Specifically, the second projection 168 extends from the circular band 152 generally parallel to the first projection 156. The second projection 168 defines a second length L2 measured in a direction perpendicular to the longitudinal axis A1 from the circular band 152. In the illustrated construction, the first length L1 is greater than the second length L2. The first projection 156 and the second projection 168 define a gap G1 therebetween. The gap G1 is configured to receive a support structure 172 (FIGS. 14 and 15) to support the portable fan 100 on the support structure 172. In some constructions, the gap G1 is between 10 and 40 millimeters. In the illustrated construction, the gap G1 is 21 millimeters.

With reference to FIGS. 1 and 2, the portable fan 100 includes a second arm 176 rotatably coupled to the main body 104 about the longitudinal axis A1 relative to the fan head 132, the central member 128, and the first arm 148. Specifically, the second arm 176 includes a circular band 180 rotatably coupled to the main body 104 about the longitudinal axis A1 relative to the fan head 132 and the central member 128. The second arm 176 is disposed between the first end 112 and the second end 116. Specifically, the circular band 180 is disposed between the second end 116 and the central member 128. The second arm 176 includes a third projection 184 extending outwardly from the main body 104. Specifically, the third projection 184 extends from the circular band 180. In the illustrated construction, the third projection 184 defines a second distal end 188 that is opposite from the main body 104 (e.g., opposite a portion of the third projection 184 that extends from the circular band 180). The third projection 184 is generally shorter than the first projection 156. In addition, the third projection 184 is generally straight or only has a slight curvature compared to the first projection 156.

The second arm 176 includes a fourth projection 192 spaced apart from the third projection 184 and extending outwardly from the main body 104. Specifically, the fourth projection 192 extends from the circular band 180 generally parallel to the third projection 184. The fourth projection 192 defines a length measured in a direction perpendicular to the circular band 180 that is generally equal to the second length L2 of the second projection 168. As such, the second and fourth projections 192, 168 have similar configurations. In addition, the length of the fourth projection 192 is less than a length of the third projection 184. The third projection 184 and the fourth projection 192 define the gap G1 therebetween such that the support structure 172 can be received in the gap G1.

With reference to FIGS. 1 and 2, the portable fan 100 is in a first arm position in which the second distal end 188 is coupled to the first distal end 160. In the first arm position, the first arm 148 and the second arm 176 cooperate to form a closed loop. In the illustrated construction, the closed loop is curved (e.g., circular, oval-shaped, oblong, or the like). In other constructions, the closed loop may be a rectangle. In other constructions, the closed loop may be another polygonal shape (e.g., a triangle, a quadrilateral, a hexagon). In other words, the first arm 148 and the second arm 176 may have a different profile than illustrated such that the desired shape of the closed loop is formed. Additionally, FIGS. 1 and 2 illustrate the portable fan 100 in a first fan head position. In the first fan head position, the fan head 132 lies flat in the closed loop (e.g., the first arm 148 and the second arm 176 in the first arm position). In this position, a portion of the fan head 132 is received within the closed loop. Specifically, a portion of the fan head 132 that supports the motor and extends rearwardly from the inlet grate 136 is received within the closed loop. In some embodiments, at least part of the inlet grate 136 may also be received within the closed loop. The profile defined by the closed loop is similar to an outer profile defined by the inlet grate 136. That is, the closed loop has a curvature that generally matches a curvature of the inlet grate 136. In addition, the closed loop is generally the same size as the inlet grate such that the inlet grate generally fits within an outer profile, or footprint, of the closed loop.

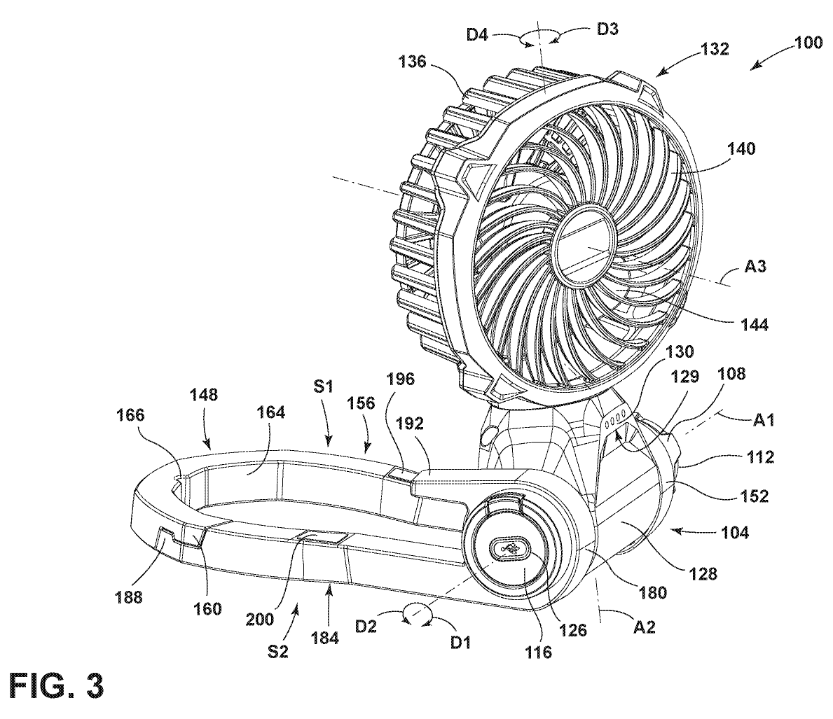

FIG. 3 illustrates that the fan head 132 and the central member 128 are rotatable about the longitudinal axis A1 in a first direction D1 and a second direction D2 opposite the first direction D1 relative to the first arm 148 and the second arm 176. Specifically, the fan head 132 was rotated in the first direction D1 from the first head position (FIGS. 1 and 2) to a second fan head position (FIG. 3). In the second fan head position, the fan head 132 is spaced apart from the closed loop. That is, the fan head 132 is angularly displaced from the first arm 148 and the second arm 176 about the longitudinal axis A1. In the illustrated construction, the fan head 132 is rotatable nearly 310 degrees about the longitudinal axis A1. In other constructions, the fan head 132 is rotatable between 240 degrees and 360 degrees about the longitudinal axis A1. FIG. 3 illustrates that the fan head 132 is rotatable about the bisecting axis A2 in a third direction D3 and a fourth direction D4 opposite the third direction D3 relative to the first arm 148 and the second arm 176. Specifically, the fan head 132 was rotated in the third direction D3 from the position illustrated in FIGS. 1 and 2 to the position illustrated in FIG. 3. In the illustrated construction, the fan head 132 is rotatable 334 degrees about the bisecting axis A2. In other constructions, the fan head 132 is rotatable between 240 degrees and 360 degrees about the bisecting axis A2.

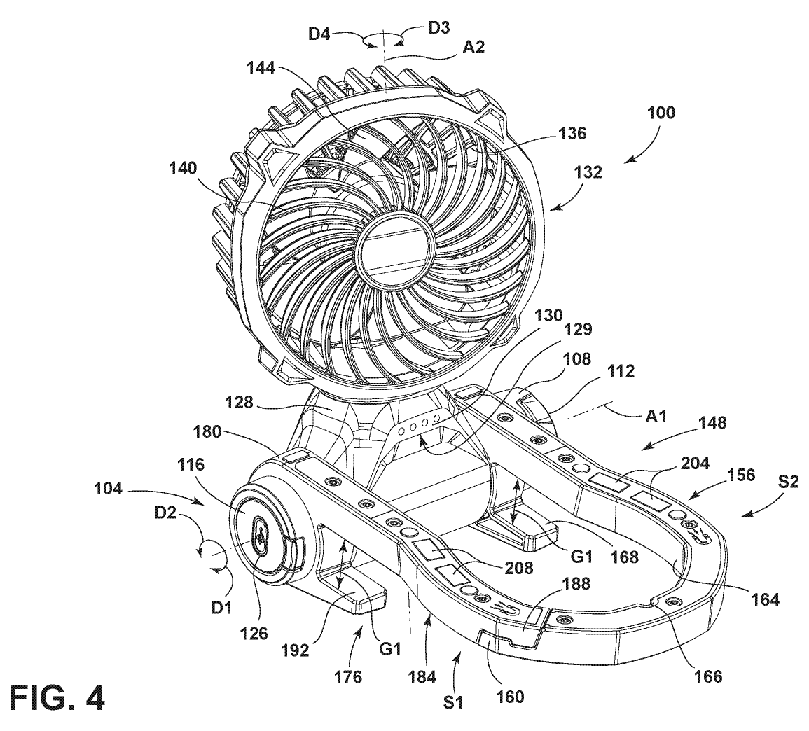

FIG. 3 illustrates that the first projection 156 defines a first side S1 and a second side S2 opposite the first side S1 (FIG. 4). The first side S1 of the first projection 156 faces the second projection 168. The first projection 156 includes an optional pad 196. In the illustrated construction, the pad 196 is disposed on the first side S1 of the first projection 156. The pad 196 is placed on the first projection 156 to prevent marring of the support structure 172 when the support structure 172 is received in the gap G1. The third projection 184 defines the first side S1 and the second side S2. The third projection 184 includes an optional pad 200 to prevent marring of the support structure 172. In the illustrated construction, the pad 200 is disposed on the first side S1 of the third projection 184. In other constructions, the pads 196, 200 can be located near to the circular bands 152, 180, respectively. In other constructions, the projections 168, 192 include pads.

FIG. 4 illustrates the second side S2 of the first projection 156. The second side S2 of the first projection 156 faces away from the second projection 168. The first projection 156 includes one or more magnets 204. In the illustrated construction, the magnets 204 are disposed on the second side S2 of the first projection 156. That is, the pad 196 and the magnets 204 are disposed on opposite sides of the first projection 156 (e.g., the first side S1 and the second side S2). The magnets 204 are configured to magnetically couple the portable fan 100 to the support structure 172 having a ferromagnetic material. The third projection 184 includes one or more magnets 208. The magnets 208 are disposed on the second side S2 of the third projection 184. In other words, the pad 200 and the magnets 208 are disposed on opposite sides of the third projection 184. The magnets 208 are configured to magnetically couple the portable fan 100 to a support structure 172 made from a ferromagnetic material. In the illustrated construction, the portable fan 100 includes circular pads 210 on the second side S2 next to the magnets 204, 208 (FIG. 2). In the illustrated construction, the portable fan 100 includes rectangular pads 211 on the second side S2 on the circular bands 152, 180 (FIG. 2).

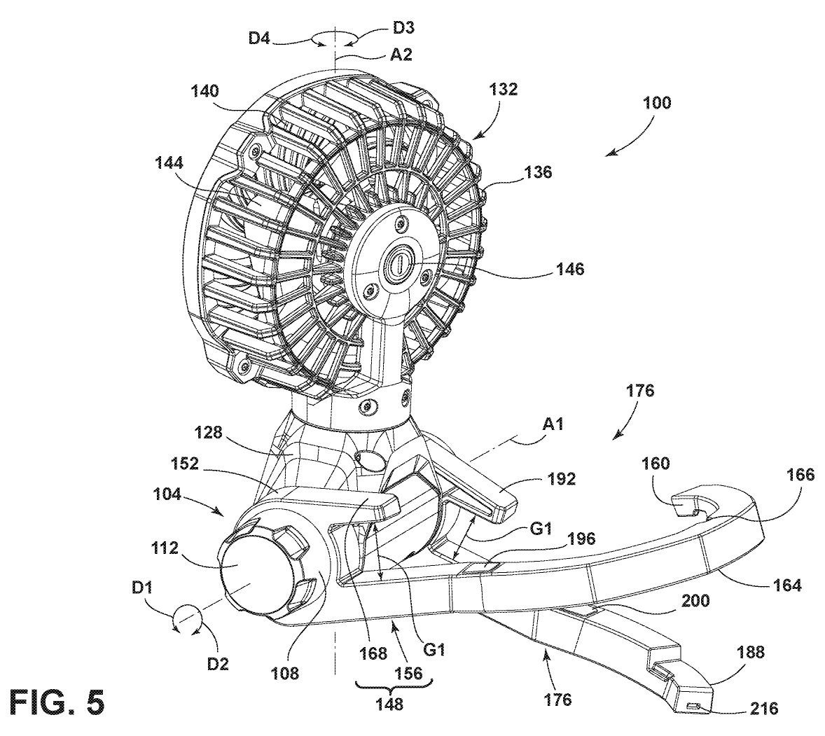

FIG. 5 illustrates the portable fan 100 in a second arm position in which the second distal end 188 is spaced apart from the first distal end 160. The capability of the first distal end 160 and the second distal end 188 being spaced apart from one another is a result of the first arm 148 and the second arm 176 being independently rotatable about the longitudinal axis A1 relative to one another. In other words, the first arm 148 and the second arm 176 are spaced apart from each other due to angular displacement about the longitudinal axis A1. The first arm 148 is capable of 310-degree rotation about the longitudinal axis A1. In other constructions, the first arm 148 is rotatable between 240 degrees and 360 degrees about the longitudinal axis A1. The second arm 176 is capable of 359-degree rotation about the longitudinal axis A1. In other constructions, the second arm 176 is rotatable between 240 degrees and 360 degrees about the longitudinal axis A1.

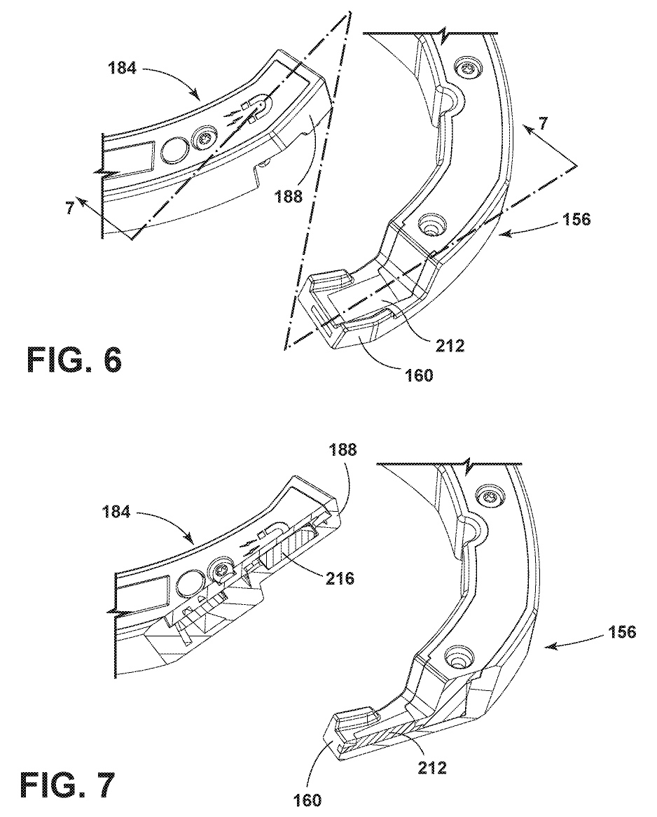

FIGS. 6 and 7 illustrate the portable fan 100 in the second arm position with the first distal end 160 spaced from the second distal end 188. In the illustrated construction, the first arm 148 includes a ferromagnetic plate 212 (e.g., constructed of a ferromagnetic material). In the illustrated constructions, the ferromagnetic plate 212 is a metal plate such as steel. In other constructions, the first arm 148 includes a magnet. That is, the ferromagnetic plate 212 is replaced with a magnet. The ferromagnetic plate 212 is adjacent to the first distal end 160 of the first arm 148. In the illustrated construction, the second arm 176 includes a magnet 216. In other constructions, the second arm 176 includes a ferromagnetic material. That is, the magnet 216 is replaced with a ferromagnetic material such as a steel plate. The magnet 216 is adjacent to the second distal end 188 of the second arm 176. In the illustrated construction, the magnet 216 is disposed centrally within the second distal end 188. The magnet 216 is coupled with two steel plates to direct the magnetic flux toward metal plate 212 for a stronger magnetic latch. In the first arm position, the ferromagnetic plate 212 is magnetically latched to the magnet 216 such that the first arm position is maintained by the attractive forces from the ferromagnetic plate 212 and the magnet 216.

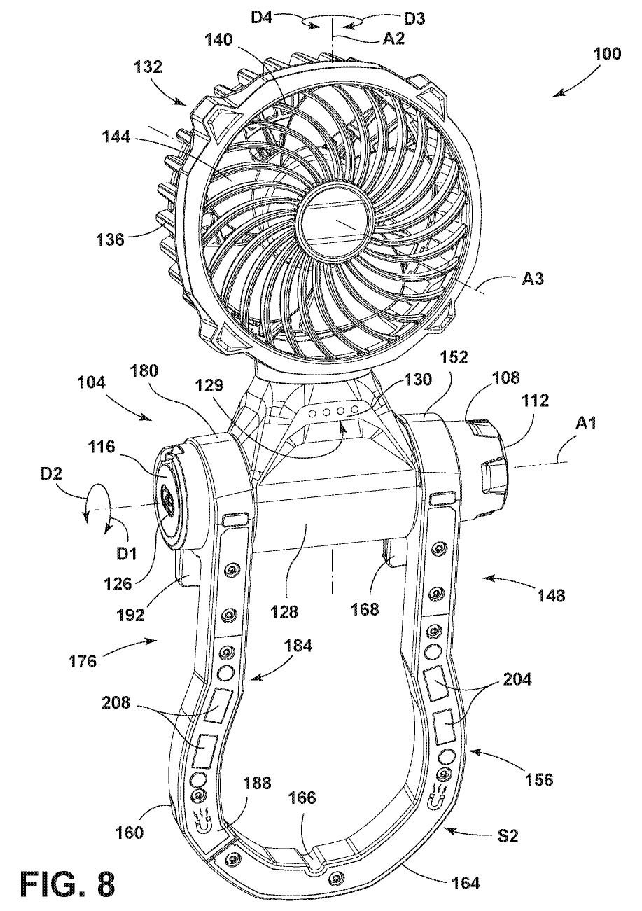

FIG. 8 illustrates the portable fan 100 in the first arm position. From the position of the portable fan 100 illustrated in FIG. 5, the second arm 176 was rotated in the second direction D2 such that the first arm 148 and the second arm 176 form the closed loop. The fan head 132 has dual pivot articulation relative to the first arm 148 and the second arm 176.

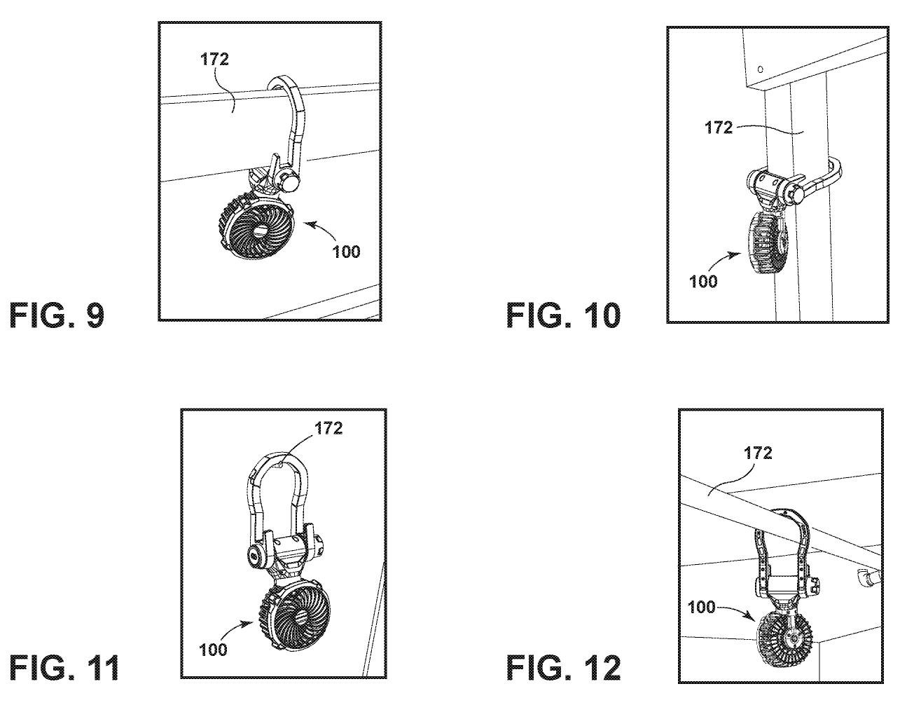

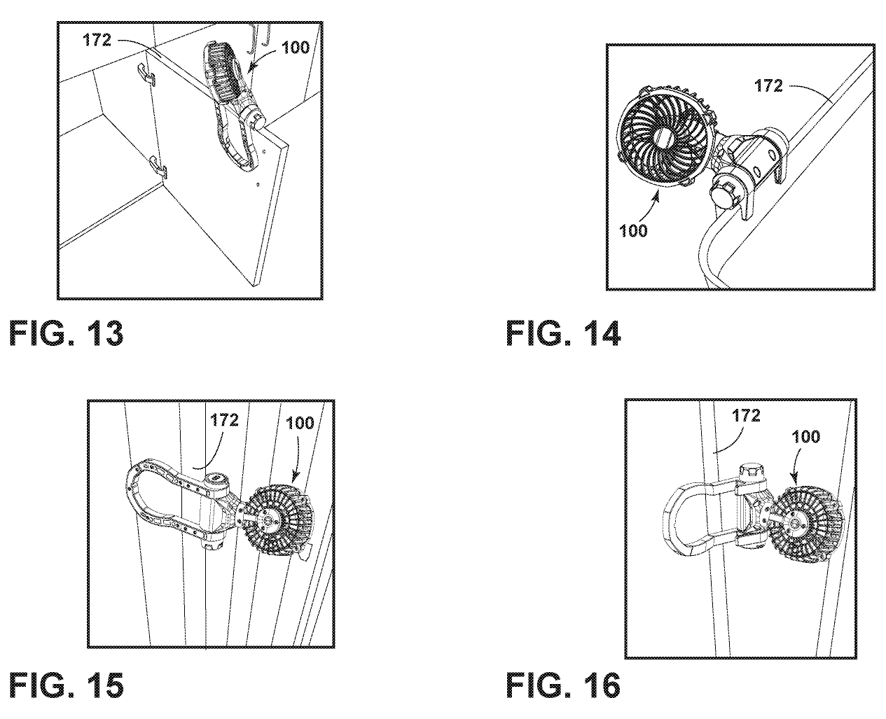

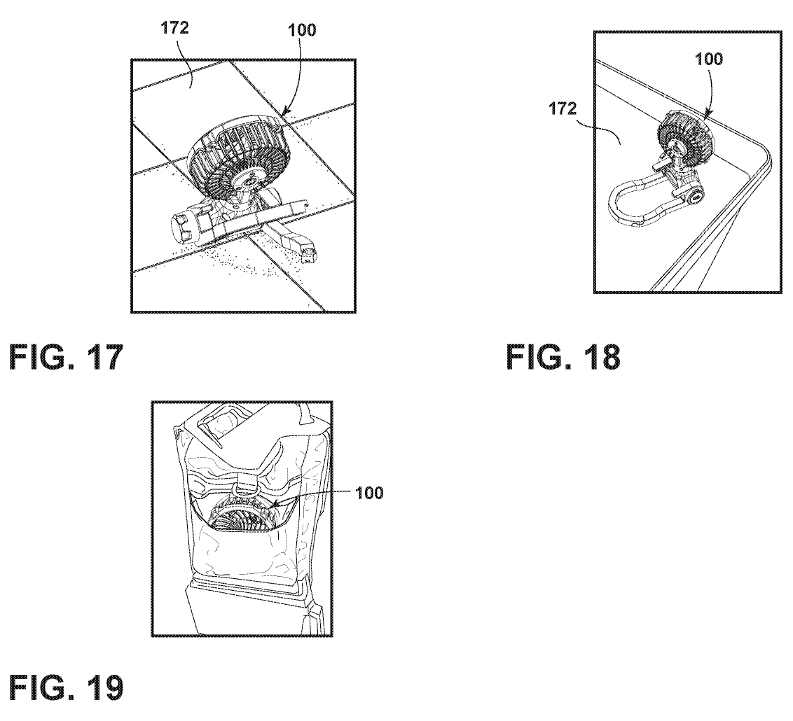

FIGS. 9-18 illustrate the portable fan 100 hung from or mounted to various support structures 172. FIG. 9 illustrates the portable fan 100 hung from the support structure 172 (e.g., a horizontal piece of wood). FIG. 10 illustrates the portable fan 100 hung from the support structure 172 (e.g., a vertical piece of wood). FIG. 11 illustrates the portable fan 100 hung from the support structure 172 (e.g., a nail) by receiving the support structure 172 with the recess 166 of the first projection 156. The recess 166 can receive the support structure 172 in the first arm position or the second arm position. FIG. 12 illustrates the portable fan 100 hung from the support structure 172 (e.g., a tube) in the first arm position. Specifically, the support structure 172 passes through the closed loop. FIG. 13 illustrates the portable fan 100 mounted to the support structure 172 (e.g., a door) in the first arm position. Specifically, the support structure 172 is received in the gap G1. FIG. 14 illustrates the portable fan 100 mounted to the support structure 172 (e.g., a vertical wall of a cart) in the first arm position. Specifically, the support structure 172 is received in the gap G1. FIG. 15 illustrates the portable fan 100 mounted to the support structure 172. The support structure 172 is received in the gap G1. FIG. 16 illustrates the portable fan 100 mounted to the support structure 172 (e.g., a curved ferromagnetic surface) in the first arm position. Specifically, the magnets 204, 208 magnetically attach to the support structure 172. FIG. 17 illustrates the portable fan 100 standing relative to the support structure 172 (e.g., a floor). Specifically, the portable fan 100 is in the second arm position with the first arm 148 engaging the support structure 172 and the second arm 176 spaced from the first arm 148. FIG. 18 illustrates the portable fan 100 standing relative to the support structure 172 (e.g., a horizontal surface). Specifically, the portable fan 100 is in the first arm position with the first arm 148 and the second arm 176 engaging the support structure 172.

FIG. 19 illustrates the portable fan 100 in the first arm position and the first fan head position such that the portable fan 100 can be stowed in the first head position.

Although the disclosure has been described in detail with reference to certain preferred constructions, variations and modifications exist within the scope and spirit of one or more independent aspects of the disclosure as described.

Various features of the disclosure are set forth in the following claims.

What is claimed is:

1. A portable fan comprising:
a main body including a first end and a second end opposite the first end;
a fan head coupled to the main body between the first end and the second end, the fan head including a fan configured to be selectively powered by a power source;
a first arm rotatably coupled to the main body relative to the fan head, the first arm including a first distal end opposite from the main body; and
a second arm rotatably coupled to the main body relative to the fan head and the first arm, the second arm including a second distal end opposite the main body, the second arm being rotatable relative to the first arm between a first arm position, in which the second distal end is coupled to the first distal end, and a second arm position, in which the second distal end is spaced apart from the first distal end.

2. The portable fan of claim 1, wherein the first arm is rotatably coupled to the main body closer to the first end than to the second end, and wherein the second arm is rotatably coupled to the main body closer to the second end than to the first end.

3. The portable fan of claim 1, wherein the first arm includes a first projection defining the first distal end and extending outward from the main body, and a second projection spaced apart from the first projection and extending outward from the main body generally parallel to the first projection.

4. The portable fan of claim 3, wherein the first projection defines a first side and a second side opposite the first side, wherein the first side faces the second projection, and wherein the second side includes a pad.

5. The portable fan of claim 4, wherein the second arm includes a third projection defining the second distal end and extending outward from the main body, and a fourth projection spaced apart from the third projection and extending outward from the main body generally parallel to the third projection.

6. The portable fan of claim 4, wherein the first projection includes a bend such that the first projection is J-shaped.

7. The portable fan of claim 1, wherein the first arm includes a ferromagnetic plate adjacent to the first distal end, wherein the second arm includes a magnet adjacent to the second distal end, and wherein the ferromagnetic plate selectively couples to the magnet when the second arm is in the first arm position.

8. The portable fan of claim 1, wherein in the first arm position, the first arm and the second arm cooperate to form a closed loop.

9. The portable fan of claim 8, wherein the fan head is rotatable relative to the first arm and the second arm between a first fan head position, in which the fan head lies flat on the closed loop, and a second fan head position, in which the fan head is spaced apart from the closed loop.

10. The portable fan of claim 1, wherein the main body includes a battery receptacle configured to receive a battery, and wherein the battery is the power source.

11. The portable fan of claim 10, wherein the main body defines a longitudinal axis extending through the first end and the second end, wherein the first arm and the second arm are independently rotatable about the longitudinal axis, and wherein the battery receptacle is configured to receive the battery along the longitudinal axis.

12. A portable fan comprising:
a main body;
a fan head coupled to the main body, the fan head including a fan configured to be selectively powered by a power source; and
a first arm rotatably coupled to the main body relative to the fan head, the first arm including
a first projection extending outwardly from the main body, and
a second projection spaced apart from the first projection and extending outwardly from the main body generally parallel to the first projection, the first projection and the second projection defining a gap therebetween, the gap configured to receive a support structure to support the portable fan on the support structure.

13. The portable fan of claim 12, wherein the first projection defines a first length and the second projection defines a second length, and wherein the first length is greater than the second length.

14. The portable fan of claim 12, wherein the first projection defines a first side facing the second projection and a second side opposite the first side, and wherein the first projection includes a pad on the second side.

15. The portable fan of claim 14, wherein the first projection includes a magnet on the second side.

16. The portable fan of claim 12, wherein the first arm further includes a circular band coupled to the main body, and wherein the first projection extends from the circular band.

17. The portable fan of claim 16, wherein the main body includes a first end and a second end opposite the first end, and wherein the circular band is coupled to the main body closer to the first end than to the second end.

18. A portable fan comprising:
a main body including a first end and a second end opposite the first end;
a fan head coupled to the main body between the first end and the second end, the fan head including a fan configured to be selectively powered by a power source;
a first arm rotatably coupled to the main body relative to the fan head, the first arm including a first distal end opposite from the main body; and
a second arm rotatably coupled to the main body relative to the fan head and the first arm, the second arm including a second distal end opposite the main body, the second arm being rotatable relative to the first arm between a first arm position, in which the second distal end is coupled to the first distal end such that the first arm and the second arm cooperate to form a closed loop, and a second arm position, in which the second distal end is spaced apart from the first distal end,
wherein the fan head is rotatable relative to the first arm and the second arm between a first fan head position, in which a portion of the fan is received in the closed loop, and a second fan head position, in which the fan head is spaced apart from the closed loop.

19. The portable fan of claim 18, wherein the main body defines a longitudinal axis extending through the first end and the second end, and wherein the fan head is rotatable relative to the first arm and the second arm about the longitudinal axis.

20. The portable fan of claim 19, further comprising a central member disposed on the main body between the first end and the second end, wherein the fan head is coupled to the main body via the central member, wherein the central member defines a bisecting axis that extends through the central member and is perpendicular to the longitudinal axis, and wherein the fan head is rotatable relative to the first arm and the second arm about the bisecting axis.
